(19) United States
(12) Patent Application Publication
(10) Pub. No.: US 2019/0211944 A1
(43) Pub. Date: Jul. 11, 2019

(54) FLUID CONTROL VALVE

(71) Applicant: Dominic P. Ismert, Marshall, MI (US)

(72) Inventor: Dominic P. Ismert, Marshall, MI (US)

(21) Appl. No.: 15/867,448

(22) Filed: Jan. 10, 2018

(51) Int. Cl. F16K 31/524; F16K 1/12; F16K 1/30; F16K 31/60; F16K 27/02

(52) U.S. Cl. CPC F16K 31/52408; F16K 1/12; F16K 27/02; F16K 31/602; F16K 1/301

(57) ABSTRACT

A two-part housing interconnects inlet and outlet fittings in fixed relation to form a valve body having an elongate internal chamber. The chamber includes a piston having a seal and cyclically slidable from a closed, flow-restricting position, to an open position. A cam within the chamber engages a follower on the piston outer surface and is driven by an external handle. Certain valve bodies are formed by connecting inlet and outlet fittings. An actuator includes a two-part collapsible cam insertable through the chamber and into a bonnet. Following piston installation, the cam is extended by an external handle to engage a follower on the piston surface. Another actuator includes a body-encircling ring having a cam track on the interior surface. One end of a follower engages the track and another end engages the piston. Rotation of the ring and track drives the piston within the chamber to control liquid flow through the valve.

### FIELD

The present disclosure generally relates to fluid handling devices. More particularly, it is directed to an improved valve device for controlling the flow of a fluid through a conduit.

Control valves, sometimes referred to as “stop” or “shutoff” valves, are widely used to allow or obstruct the pressurized flow of a fluid from a supply line to a point of use. When in the closed position, such valves serve to prevent the flow of fluid to the entire supply line or to isolate the flow to a particular portion of the supply line, allowing repair or replacement of lines and delivery fixtures without the need to interrupt service to other lines and fixtures. Ball valves, particularly quarter-turn ball valves, are commonly employed for this purpose because they may be quickly and easily opened and closed by supplying limited rotational motion of about 90° to a handle. Ball valves generally comprise a bored-through spherical ball-type closure member constrained within a valve body. Stationary seals are provided adjacent both the valve inlet and outlet. The ball is rotatable by a handle attached to a stem between a position in which the bore is aligned with an inlet and an outlet of the valve, thereby permitting the flow of a fluid through the valve, to a position in which the ball occludes the inlet and outlet, thereby preventing fluid flow from the valve.

In domestic plumbing installations, ball valves generally have been constructed of a durable metal material such as brass, bronze or stainless steel. Formerly less costly brass and bronze valves became more costly when lead-free fittings were required for use in association with potable water. Ball valve bodies are fabricated using casting, forging, or other techniques that include machining of the interior of the valve body to stringent tolerances. Separate inserts such as sleeves may also be employed for housing the ball and seal elements. Because of the stringent tolerances, assembly of the valve body, ball, stem, and seals is difficult, and generally does not allow for automated assembly. For example, misalignment of the valve stem may damage the seat seals inside the valve and cause leakage. The requisite close tolerances and difficulty of assembly necessitate manual assembly, resulting in a more costly finished product that is subject to breakage or damage. In addition, ball valves are subject to failure if left in an intermediate position between the fully open and closed positions. Such intermediate positions expose the seal to fluid pressure and debris, which cause warping and eventually lead to significant leakage and failure during later use. Since shutoff valves may go unused for years, damage is likely to be unnoticed until the valve is urgently needed to close off the line to prevent property damage.

Accordingly, there is a need for a valve that is durable yet can be constructed economically, and that may be fabricated from mixed materials using the benefits of each, that does not require stringent tolerances in all parts, that is well-suited to automated production, that is tolerant of prolonged use in an intermediate position, and that is easily operable by a user to control the flow of a fluid through a conduit such as a pipe, tubing, or the like.

### SUMMARY

The present disclosure provides a greatly improved control valve for a fluid such as a liquid, gas, or finely divided solid. The valve is particularly well-suited for connection with a conduit such as a liquid supply line, for example, a plumbing supply line or the like, and controlling the flow of a liquid through the line. The valve includes a valve body assembly having a central housing member, an inlet fitting, and an outlet fitting that cooperatively form an internal valve chamber. The housing includes first and second sections configured to interconnect with each other and with the inlet and outlet fittings to hold the fittings in a fixed orientation and spaced relation to form the valve body. Circumferential tension bands hold the first and second housing sections and connected inlet and outlet fittings in place. The assembled valve body has an elongate cylindrical chamber that constrains a flow-restricting member or piston operated by a valve actuating mechanism. The first housing section includes an aperture for connecting a handle for manual operation of the valve actuating mechanism.

The inlet and outlet fittings each have a larger diameter housing connector connected to a smaller diameter adapter that is configured for connection to a supply line. The outer surface of each housing connector includes structure for engagement with an end of the housing and the inner surface of the housing connector forms a socket. The adapters each include a respective inlet or outlet opening in fluid communication with an interior flow channel that extends through the respective socket and communicates with an interior flow channel within the piston to enable the passage of fluid through the valve body when the valve is in an open position.

The outer surface of the piston adjacent the inlet and outlet portions of the piston inlet and outlet ports is equipped with seals for sealing the outer surface of the piston against the inner surface of the valve chamber. The piston terminates in a boss that is positioned outboard of the piston outlet port or ports. The boss is equipped with a seal configured for reception in a seat at the junction of the outlet socket and adapter. A portion of the outer surface of the piston midsection is configured to form a cam follower. An opposed portion of the outer surface of the midsection includes a centering tab that rides back and forth between inwardly extending centering structure, such as legs formed in the second housing section.

The valve actuating mechanism includes a handle connected to a cam element having a shaft defining a first axis. When driven by turning the handle along the first axis, the cam moves the cam follower on the surface of the piston, urging the piston longitudinally within the chamber, thereby controlling the flow of liquid through the valve.

In one aspect, the valve actuating mechanism includes a key assembly for locking the piston in a predetermined position. The key assembly includes a tab connected to an arm configured to be wedged against a plate on the outside of the first housing section. Movement of the tab to wedge the arm against the plate locks the handle against movement. Movement of the tab to free the arm allows rotation of the handle to actuate the valve.

In another embodiment, the valve includes an inlet fitting having an inlet adapter and a housing having an outlet adapter. The inlet fitting and the housing connect to cooperatively form a valve body. The valve body has an elongate, generally cylindrical internal chamber that constrains a flow-restricting member or piston operated by a valve actuating mechanism. The housing includes a raised bonnet having an aperture for connecting a handle for manual operation of the valve actuating mechanism.

The inlet fitting includes an inlet adapter configured for connection to a supply line and a housing connector configured for coupling with the housing section. The housing includes an outlet adapter section having a larger diameter socket section connected to a smaller diameter adapter configured for connection with the downstream portion of the supply line. The inlet adapter and the outlet adapter section each include a respective inlet or outlet opening in fluid communication with an interior flow channel that extends through the inlet adapter, the outlet adapter section, and the housing and communicates with an interior flow channel within the piston to enable the passage of fluid through the valve body when the valve is in an open position.

The outer surface of the piston adjacent the inlet and outlet portions of the piston inlet and outlet ports includes seals for sealing the outer surface of the piston against the inner surface of the valve chamber. The piston terminates in a boss positioned outboard of the piston outlet port. The boss includes a seal that is received in a seat at the junction of the outlet socket and adapter. A portion of the outer surface of the piston midsection is configured to form a cam follower.

The valve actuating mechanism includes a handle connected to a two-part collapsible cam having a shaft defining a first axis. The cam includes a generally hollow body and a slidable element that is connected with the eccentric. The slidable element includes one or more shafts or legs that are received within apertures in the body to form a sliding telescopic connection that enables the element to be nested within the hollow body of the cam for insertion through the inlet end of the housing, into the valve chamber and outward into the bonnet. Securing the handle to an aperture in the cam shaft extends the legs and maintains the cam in its extended position.

When driven by the handle along the first axis, the cam moves the cam follower on the surface of the piston, urging the piston back and forth within the chamber, thereby controlling the flow of liquid through the valve.

In another embodiment, the valve includes an inlet fitting and an outlet fitting that connect to cooperatively form a valve body. The valve body has a generally cylindrical internal chamber that constrains a piston operated by a valve actuating mechanism.

The inlet fitting is configured as a reducing coupling having a larger diameter socket section connected to a smaller diameter adapter for connection with a supply line. The inner surface of the inlet socket section includes structure for engagement with the outlet fitting. The outlet fitting is configures as an elongated reducing coupling having a generally cylindrical hollow inboard housing section connected to a socket section that is in turn connected to a smaller diameter adapter for connection with the downstream portion of the supply line. The inboard end of the outlet fitting housing section includes structure for engagement with the inlet fitting. The center portion of the housing section is bounded by first and second annular rings. A pair of obround apertures is positioned between the rings in opposed relation transverse to a second axis defined by the linear movement of the piston within the chamber. The adapter sections of the inlet and outlet fittings each include a respective inlet or outlet opening in fluid communication with an interior flow channel that extends through the respective socket section, and an interior flow channel within the piston to enable the passage of a fluid such as water through the valve body when the closure member is in an open position.

The outer surfaces of the inlet and outlet portions of the piston are equipped with seals for sealing the outer surface of the piston against the inner surface of the valve body chamber. The piston terminates in a boss positioned outboard of the piston outlet port. The boss is equipped with a seal configured for reception in a seat at the junction of the outlet socket and adapter. The generally cylindrical midsection of the piston includes a pair of apertures positioned in opposed relation transverse to the second axis.

The valve actuating mechanism includes a rotatable ring having a helical cam track on the interior surface that is engaged by a pair of cam followers mounted on a pair of semicircular clips that connect together to encircle the external surface of the outlet housing section. One end of each follower engages the track. Another end extends through the obround aperture for engagement with a piston aperture. Rotation of the ring and track drives the piston within the chamber to control the flow of liquid through the valve.

Various objects, features and advantages of this disclosure will become apparent from the following detailed description, which, taken in conjunction with the accompanying drawings, which depict, by way of illustration and example, certain embodiments of this improved valve.

The drawings constitute a part of this specification, include exemplary embodiments of the valve, and illustrate various objects and features thereof.

### BRIEF DESCRIPTION OF THE DRAWINGS

FIG. 1 is a perspective view of an exemplary valve in accordance with the disclosure.

FIG. 2 is an exploded perspective view of the valve of FIG. 1.

FIG. 3 is a side sectional view of the valve of FIG.1 shown in a closed position.

FIG. 4 is a side sectional view similar to FIG. 3 with the valve in an open position.

FIG. 5 is a top perspective view of the piston of FIG. 2.

FIG. 6 is a side perspective view of the piston of FIG. 2.

FIG. 7 is a perspective view of the cam of FIG. 2.

FIG. 8 is a side elevational view of an embodiment of a valve having a locking key assembly.

FIG. 9 is a sectional perspective view of an embodiment having a telescoping cam showing the cam in an extended position.

FIG. 10 is an enlarged perspective view of the cam of FIG. 9.

FIG. 11 is a perspective view of the slidable portion of the cam of FIG. 9

FIG. 12 is a side sectional view of the cam of FIG. 10 but showing the cam in a collapsed position.

FIG. 13 is a perspective view of an embodiment of a valve having a rotatable cam track.

FIG. 14 is an exploded perspective view of the valve of FIG.13.

FIG. 15 is a side sectional view of the valve of FIG. 13 with the valve in a closed position.

FIG. 16 is a side sectional view similar to FIG. 15 with the valve shown in an open position.

### DETAILED DESCRIPTION

Selected detailed embodiments of the modular support system will now be disclosed with reference to the drawings. It will be apparent to those skilled in the art that the following descriptions of the aspects of the embodiments are provided for illustration only and not for the purpose of limiting the invention as defined by the appended claims and their equivalents.

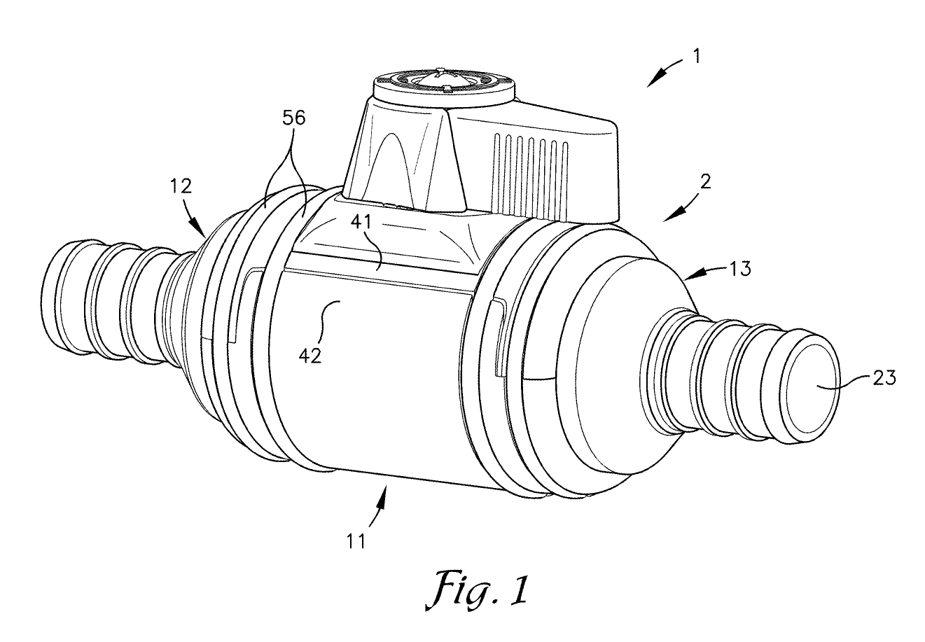

Referring now to the drawing figures, the reference numeral 1 designates a valve that is configured for in-line connection with a fluid supply line such as a plumbing supply line or the like. As shown in FIGS. 1-7, the valve 1 includes an elongate, multi-part valve body assembly 2 having an elongate generally cylindrical internal chamber 3 that constrains a flow restricting or valve closure member 4 that is operable by a valve actuating mechanism 5 to open and close the valve.

In more detail, the valve body assembly 2 includes a central housing member 11 that interconnects an inlet fitting 12 and an outlet fitting 13 to form a fluid flow passageway or channel 16 therebetween. The inlet and outlet fittings 12 and 13 each include a respective inlet or outlet adapter, or pipe or hose tail connector 14 or 15. The adapters have a smaller diameter and are each connected with a respective inlet or outlet housing connector 20 or 21 having a larger diameter. The generally tubular inlet adapter 14 includes an inlet opening or port 22, and the outlet adapter 15 includes an outlet opening or port 23. The exterior surfaces of the inlet and outlet adapters 14 and 15 each include a series of spaced apart concentric rings 24 for engaging the inner surface of a fluid supply line such as PEX tubing. Taper threads may be substituted for the concentric rings 24 to form a barbed connection. The inlet and outlet fittings 12 and 13 are preferably constructed of a metal material such as brass, copper, stainless steel or aluminum. In another aspect, the adapter connections may be constructed for connection with metal piping such as brass or copper by soldering or brazing, and the concentric rings 24 may be omitted. In still another aspect, the inlet and outlet fitting may be constructed of a synthetic or semisynthetic resin or plastic material.

The inner surface of each of the inlet and outlet housing connectors 20 and 21 is configured to form a respective cavity or socket 25 and 26. The inlet socket 25 has a generally cylindrical overall interior configuration including a generally cylindrical sidewall connected with a generally planar inlet socket endwall 31. The socket endwall 31 includes a central aperture sized to provide a flow passageway or channel 16 from the inlet adapter 14 through the piston 4 when the valve is in an open position. The interior configuration of the outlet socket 26 is that of a reducing coupling, and includes a generally cylindrical sidewall connected to a generally funnel-shaped outlet socket endwall 32. The socket endwall 32 includes a central aperture sized to allow continuation of the flow channel 16 from the outlet socket 26 to the outlet adapter 15 when the valve is in an open position.

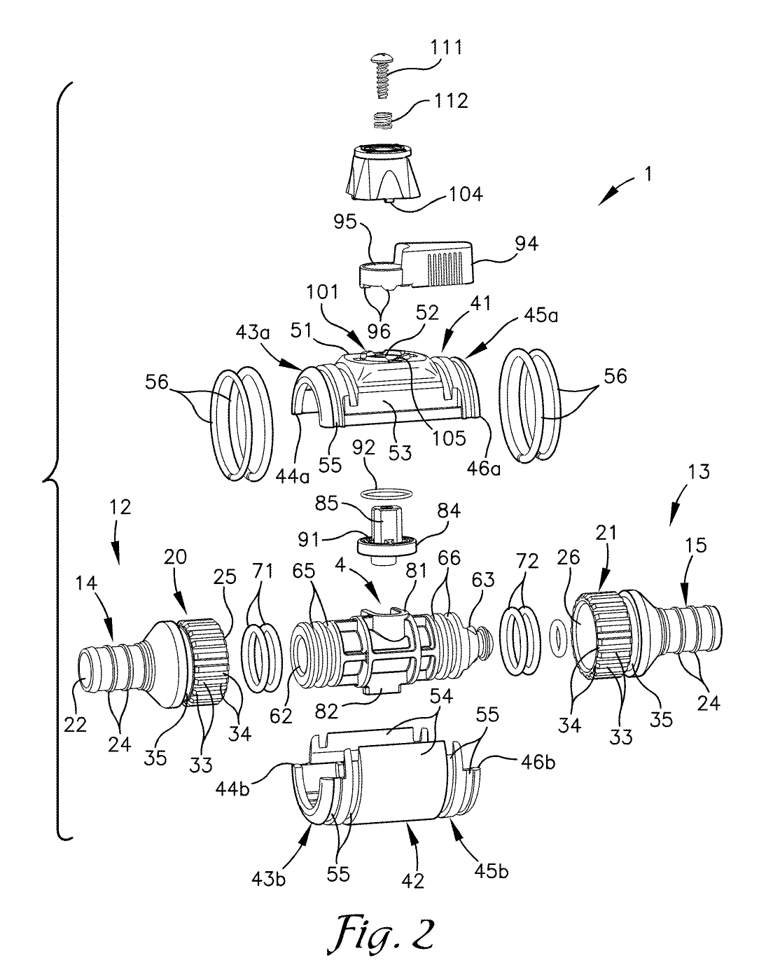

The exterior surfaces of the inlet and outlet housing connectors 20 and 21 each include a series of spaced apart axial ridges or lands 33 with grooves 34 therebetween for registration with corresponding lands and grooves on the interior surface of the housing 11 to constrain the inlet and outlet fittings 12 and 13 against rotation about the second axis. The exterior surface of each housing connector also includes an encircling groove 35 (FIG. 2) positioned outboard of the lands and grooves 33 and 34.

The central housing member 11 is longitudinally split to include a first housing section 41 and a second housing section 42 (FIGS. 2-4). The housing 11 has a first or inlet end terminating in an axially biased first clamping edge and a second or outlet end terminating in a second axially biased clamping edge. These housing parts are correspondingly split into first and second section inlet ends 43a and 43b having respective first and second inlet end clamping edges 44a and 44b, and first and second section outlet ends 45a and 45b, having first and second respective outlet clamping edges 46a and 46b.

The central portion of the first housing section 41 includes a radially expanded bonnet portion 51 for accommodating parts of the valve actuating mechanism 5. The bonnet includes a central aperture 52. The inner surface of the bonnet 51 is laterally bounded by a pair of spaced-apart legs 47 that further constrain the ends of the inlet and outlet fittings 12 and 13 from movement along the longitudinal axis of the first housing section 41. The central portion of the second housing section 42 includes an interior depression or groove 61 for accommodating parts of the valve closure member 4 that is bounded by a pair of spaced apart legs 48 that further constrain the ends of the inlet and outlet fittings from movement along the longitudinal axis of the second housing section 42.

A portion of each longitudinal margin of the first housing section 41 is relieved to form a rectangular indent or groove 53. A portion of each longitudinal margin of the second housing section 42 is extended to form a generally rectangular overlap or tongue 54 for registry with the corresponding groove 53. The exterior surfaces of the first and second housing sections include pairs of grooves 55 adjacent each end for receiving respective pairs of tension bands 56 for retaining the parts of the valve body assembly 2 in place once they have been assembled. In another aspect, the first and second housing sections may be held together using a fusion bonding process such as ultrasonic bonding, solvent bonding, ultraviolet bonding or by mechanical means such as tension bands. The tension bands 56 may be constructed of any suitable material such as high tension steel, stainless steel, or any other suitable material.

The first and second housing sections 41 and 42 cooperatively engage and hold the inlet and outlet fittings 12 and 13 together in a preselected orientation and spaced relation. The inlet and outlet housing connector lands 33 and axial grooves 34 engage corresponding grooves and ridges formed on the interior surfaces of the first and second housing sections, thereby preventing axial rotation of the inlet and outlet fittings 12 and 13 or the housing sections 41 and 42 independent of one another. The first and second housing section inlet and outlet clamping edges 44 and 46 engage the circular grooves 35 of the inlet and outlet housing sections 20 and 21, thereby preventing axial movement or disengagement of the inlet and outlet fittings 12 and 13 away from the first and second housing sections 41 and 42. The first housing section legs 47 and the second housing section legs 48 engage the inner ends of the first and second housing sections, thereby preventing axial movement of the housing sections toward each other. The first and second housing section tongues 54 engage the first and second housing section grooves 53 and the tension bands 55 engage the outer housing grooves 55 to cooperatively prevent disengagement of the first and second housing sections from each other. Thus constructed, the valve body 2 provides a generally cylindrical internal chamber 3 including a generally funnel-shaped area at the outlet end. The chamber functions as part of the flow channel 16 between the inlet adapter port 22 and the outlet adapter port 23.

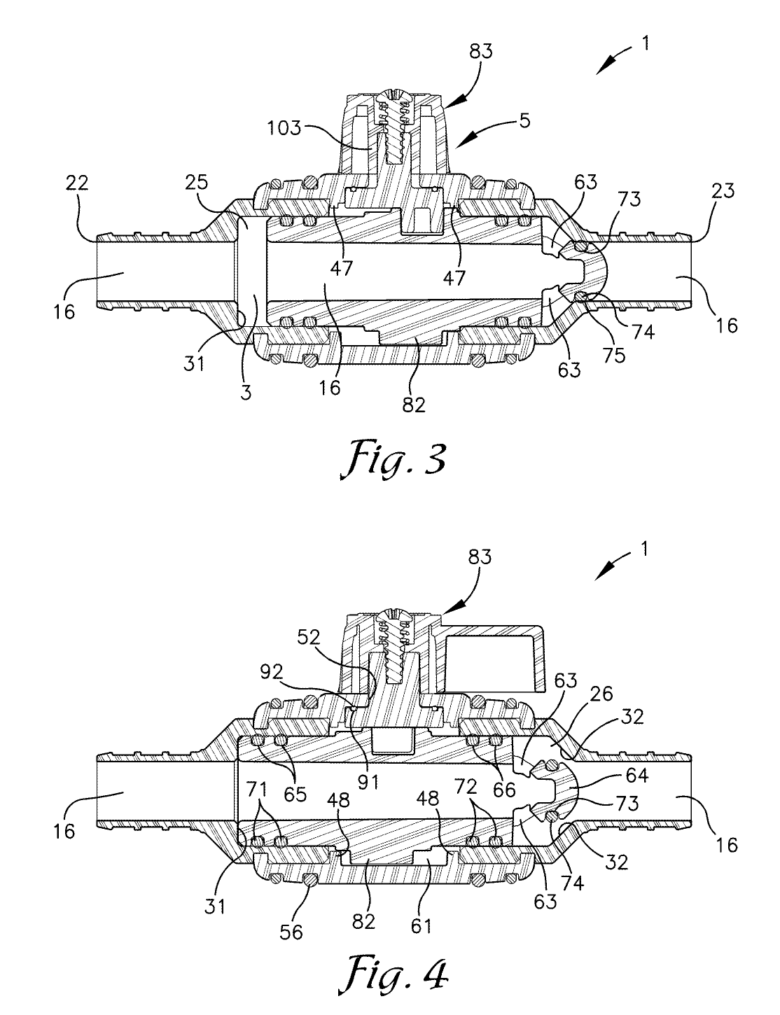

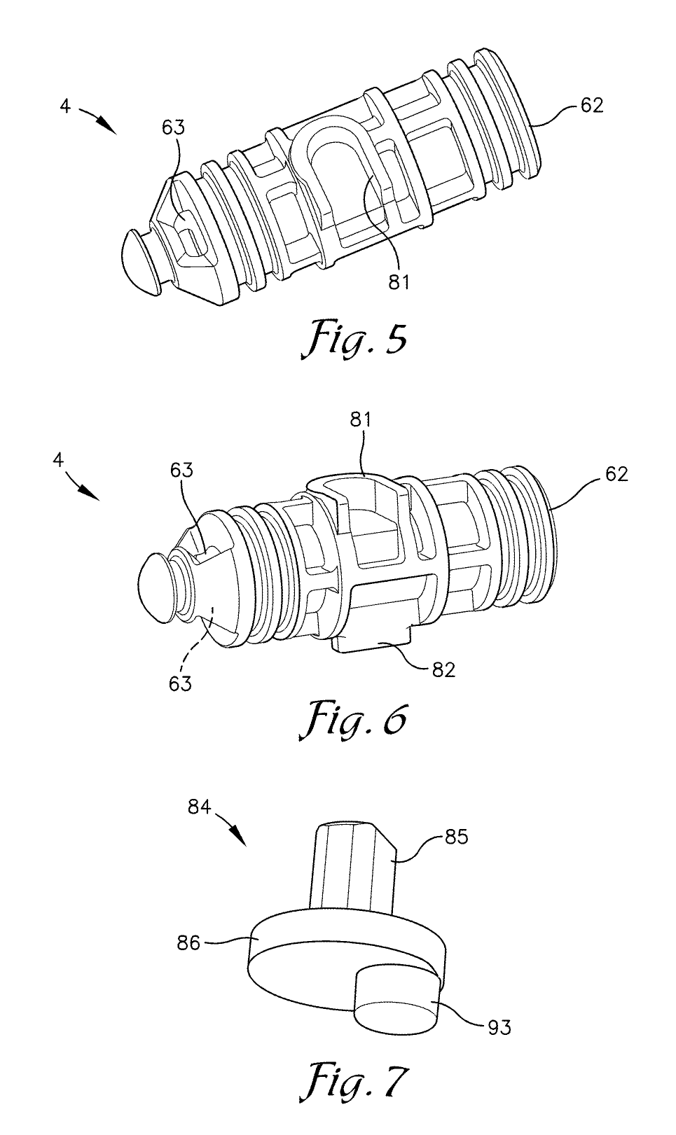

The fluid flow restricting or valve closure member 4 is preferably configured in the form of an elongate hollow cylinder or piston that is cyclically slidable back and forth within the chamber 3 from a closed position shown in FIG. 3 to an open position shown in FIG. 4. As best shown in FIGS. 5-7, the piston 4 includes an inlet end and an outlet end. The inlet end includes an opening or port 62 that is generally sized to correspond to the inner diameter of the inlet adapter port 22. One or more outlet apertures or ports 63 are positioned slightly inboard of the outlet end of the piston, which terminates in a protuberance or boss 64. The outlet ports 63 allow for passage of fluid from the hollow piston into the valve chamber 3 and outwardly through the outlet fitting 13 when the valve is in an open position. The outer surface of the piston body adjacent each of the inlet and outlet ends includes a pair of circumferential grooves 65 and 66 for mounting respective pairs of piston inlet and outlet seals 71 and 72. The seals engage the interior surfaces of the inlet and outlet sockets 25 and 26 throughout the linear movement of the piston 4 within the chamber 3 as it is moved back and forth between the closed and open positions. Thus, the piston inlet and outlet seals 71 and 72 serve to prevent the escape of water or other working fluid from the valve body 2 during operation of the valve 1. The seals 71 and 72 are shown as pairs of O-rings, which may or may not be oil-impregnated. However single or multiple numbers of seals of any other suitable type may be employed.

The piston boss 64 is configured to have a smaller diameter than the remainder of the piston 4 and includes a circumferential groove 73 for mounting a seal 74. The boss, groove, and seal are configured and sized for engagement of the seal 74 with the inner surface of the outlet adapter 15 at its junction with the outlet socket 26, which surface serves as an integral valve seat 75, for preventing outward fluid flow from the valve when the piston 4 is in the fully closed position. In another aspect, the boss, groove, and seal are configured and sized for engagement of the seal 74 with a seat element such as a seat ring connected at the junction of the outlet socket and adapter 15. In still other aspects, the boss, groove, and seal are configured and sized for engagement of the seal 74 with the inner surface of the outlet end of the inlet adapter 14, or with a seat element connected with the outlet end of the adapter 14. Those skilled in the art will appreciate that either or both socket endwalls 31 and 32 may be configured to provide a funnel shape, and either or both ends of the piston 4 may include a boss 64 and seal 74, and that a valve seat 75 may be provided at or adjacent the junctions of either or both of the inlet adapter and inlet socket and the outlet adapter and outlet socket.

A portion of the outer surface of the piston midsection is configured to include a generally U-shaped follower structure 81, positioned for reception beneath the bonnet 51 of the first housing section 41. The follower may be of integral construction with the piston or it may be separately fabricated and attached by any suitable means such as fusion bonding or welding, adhesion or fasteners. An opposed portion of the outer surface of the piston midsection includes a radial projection or centering tab 82, positioned for reception within the groove 61 of the second housing section 42.

As best shown in FIGS. 3, 4, and 7, the valve actuating mechanism 5 includes a handle 83 connected with a cam 84 that cooperates with the follower 81 to shift the piston back and forth within the chamber 3. The cam 84 includes a cam shaft 85 connected to a generally cylindrical cam body 86. The outer end of the cam shaft includes a threaded aperture to receive a fastener. The shaft 85, which has a polylateral or other non-circular cross section, or is knurled or swaged or has any other configuration or surface treatment that allows for gripping engagement, is sized for reception through the aperture 52 in the first housing section 41. The upper surface of the cam body 86 includes a groove 91 for receiving a shaft seal 92. An eccentric 93 is fixedly connected to the lower surface of the cam body in offset relation to the axis of the shaft 85 and is sized and shaped for reception within a generally U-shaped cam follower 81 formed on the surface of the piston 4. The cam 84, including the shaft, body and eccentric are preferably of integral construction and formed of a synthetic or semisynthetic resin or plastic material. It is also foreseen that the cam could be constructed of another suitable material, such as a metal, or that the cam could be constructed of mixed materials, such as one or more plastic portions connected with one or more metal portions. In another aspect, the cam, body, shaft, and handle may be of integral construction.

The handle 83 is positioned outside the valve body 2 atop the bonnet 51. The handle includes a lever 94 connected to an annular ring portion 95 sized for reception of the cam shaft 85. The lower surface of the ring includes a toothed cam 96. When the lever is turned, the cam teeth ride along an annular follower 101 having a plurality of steps and slots formed on the bonnet 51 around the housing central aperture 52. A handle body or escutcheon 102 covers the ring 95 and the outwardly projecting portion of the cam shaft 85. The interior of the escutcheon 102 is keyed, by two or more interior sidewalls or projections 103, to receive the cam shaft 85 (FIGS. 3,4). The escutcheon also includes a side opening sized to allow rotation of the handle lever 94 at least a one-quarter turn, or about 90°, and in some aspects a half turn,or about 180°, and in some aspects a three-quarter turn, or about 270°, and in some aspects a full turn, or about 360°. One or more detents 104 extend from the bottom margin of the handle body and are sized for reception in one or more corresponding slots 105 on the surface of the bonnet 51 to prevent rotation of the escutcheon 102. The escutcheon includes a central aperture at the top to receive a fastener 111 such as a screw that may be mounted with a spring 112 to bias the handle against the bonnet 51 of the valve body assembly 2. The handle may also be constructed as a handle wheel or any other suitable configuration.

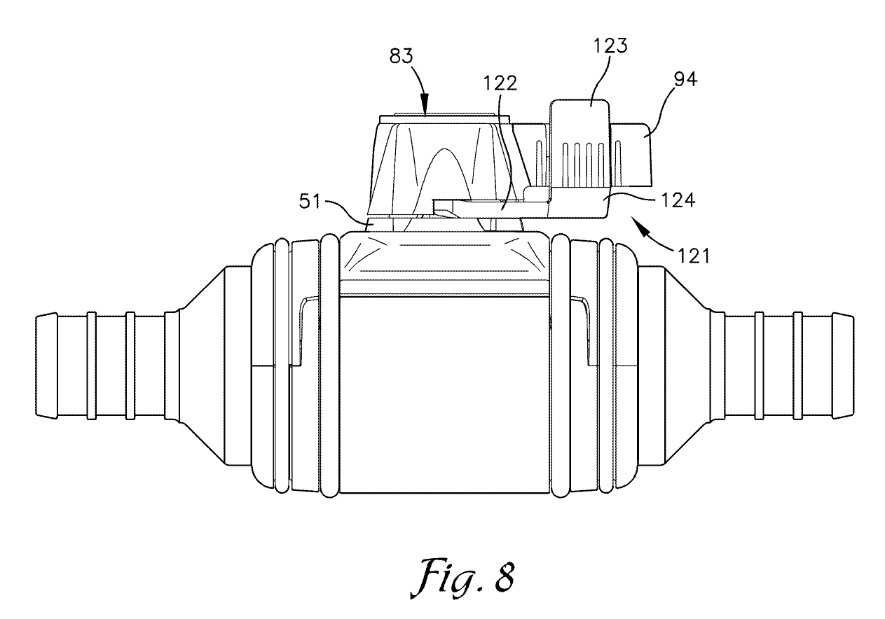

In another aspect best shown in FIG. 8, the valve actuating mechanism 5 further includes a key assembly 121 for either maintaining the handle 83 in a specified rotational orientation or for placing it in an unlocked position in which the handle lever 94 is freely rotatable. The key assembly 121 includes a plate 122 connected to the upper surface of the bonnet 51 and a tab 123 connected in upstanding relation to an arm 124. The tab 123 is rotatable between a locked position where the arm 124 is wedged against the plate 122 for maintaining the handle in a specified rotational orientation and an unlocked position where the arm 124 is disengaged from the plate 122 so that the handle lever 94 may be selectively rotated to actuate opening or closing of the valve. In this manner, the key assembly 121 operates to hold the piston 4 at a desired position within the chamber 3 when confronted with a pressure differential across the piston caused by movement of fluid through the valve body 2 that would otherwise force the piston in the direction of the fluid flow. The key assembly may also be employed to set and maintain the position of the piston 4 so that the valve 1 remains in a partially open position, thereby enabling the valve to perform a metering function.

In a method of assembling the fluid control valve of the present disclosure, the piston inlet, outlet, and boss seals 71, 72, and 74 are disposed within the respective seal grooves 65, 66, and 73. The piston 4, inlet fitting 12 and outlet fitting 13 are next disposed within the second housing section 42 with the inlet and outlet threads 44a and 46a received within the circumferential groove 35 of the appropriate fitting 12 and 13. The piston is positioned so that the centering tab 82 is received within the centering tab groove 61. The inlet and outlet fittings 12 and 13 are rotated to position the socket lands 33 within corresponding grooves on the interior of the housing section and to receive the lands on the interior of the housing section within the socket grooves 34. The cam shaft seal 92 is positioned in the cam groove 91, the cam 84 is installed with the eccentric 93 engaging the follower 81 and the cam shaft 85 is installed through the central aperture 52 in the bonnet 51. The tongues 54 are aligned with the grooves 53 of the housing sections second housing section tongues 54 are aligned with the first housing section grooves and 41, and the housing sections are urged together until fully engaged. Once the housing sections are engaged, the tension bands 56 are installed in the circumferential grooves 55 to hold the housing sections in place. The handle 83 is then installed by slipping the ring 95 over the cam shaft 85, aligning the escutcheon detents 104 with slots 105 in the bonnet 51, and urging the detents into the slots. The handle is secured in place by inserting the fastener 111 through the spring 112 and securing the fastener into the threaded aperture in the cam shaft 85. Alternatively, the handle may be secured to the shaft 85 in any suitable manner, such as adhesive bonding.

In use, to close the valve from the open position shown in FIG. 4, an operator grasps the handle lever 94 and rotates it. Rotation of the handle lever causes corresponding rotation of the cam shaft 85, which in turn moves the eccentric 93 within the follower 81 to urge the piston 4 along the second axis toward the valve seat 75. When the handle lever has been rotated about 90° about the first axis defined by the cam shaft, the piston is moved in sealing relation along the second axis within the valve chamber 3 to fully close the valve. In other aspects, rotation of the handle lever about 180°, or about 270°, or about 360° causes the piston to fully close the valve. In this position, the piston is shifted away from the inlet socket endwall 31 and toward the outlet socket endwall 32 so that the piston boss is received within the inlet end of the outlet adapter and the piston boss seal 74 engages the valve seat 75. Fluid that was previously within the fluid channel 16, having entered through the inlet adapter port 22, passed through the piston inlet port 62 and out through the piston outlet ports 63 is prevented from passage beyond the piston boss seal 74 and into the outlet adapter 15. Reverse rotation of the handle lever by a user urges the piston boss seal 74 away from the valve seat 75 and opens the fluid channel 16, enabling passage of fluid past the piston boss 64 and outwardly through the outlet adapter 15. Rotation of the handle less than about 90°, less than about 180°, less than about 270°, or less than about 360°, or less than any other amount required to fully open or close the piston operates to throttle or control the rate of fluid flow through the valve. A user may also rotate the handle any number of degrees in the forward and reverse directions until a desired flow rate is achieved.

Rotation of the handle lever about 90°, or any other preselected number of decrees, also causes the ring cam 96 to ride up on the handle follower 101 so that the cam teeth can drop into corresponding slots on the follower 101, thereby holding the handle lever 94 in place.

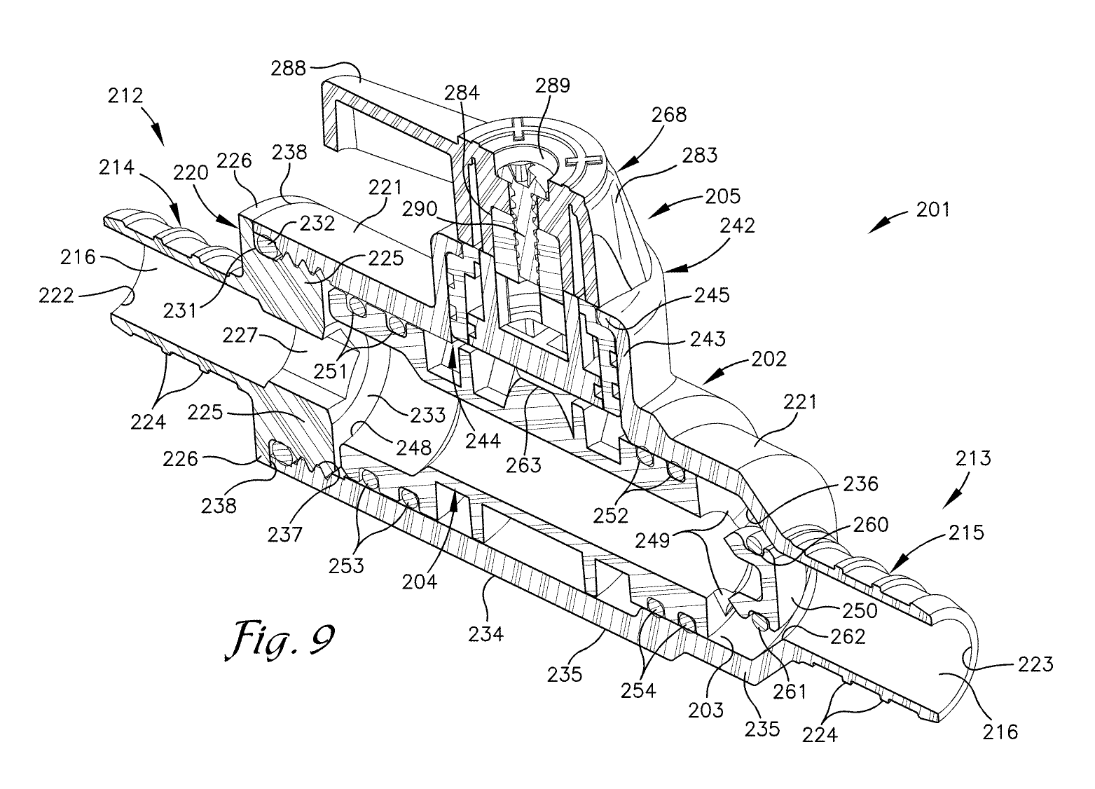

An alternate embodiment of a fluid control valve 201 is shown in FIGS. 9-12. The valve 201 includes a valve body 202 having a generally cylindrical internal chamber 203 that constrains a flow restricting or valve closure member 204 operable by a valve actuating mechanism 205 to open and close the valve.

The valve body 202 includes an inlet fitting 212 and an elongate outlet fitting 213 that interconnect to enclose an internal channel 216 for the passage of fluid. The inlet fitting and outlet fitting 212 and 213 each include a respective inlet or outlet adapter section or hose tail connector 214 and 215. The inlet adapter section 214 is connected with a housing connector section 220. The outlet adapter section 215 is connected with a housing section 221. The inlet adapter 214 includes an inlet port 222 and the outlet adapter 215 includes an outlet port 223. The exterior surfaces of the inlet and outlet adapters each include a plurality of spaced concentric rings 224 and may be constructed of the same metal or plastic materials as previously described.

The housing connector 220 includes an externally threaded portion 225 connected with an outstanding flange or shoulder 226. The threading terminates in spaced relation to the shoulder 226 leaving a corner space or groove 231 between the threading and the shoulder 226 for receiving a seal 232 such as an O-ring or the like as previously described. The inboard end of the inlet fitting 212 serves as the inlet endwall 233 of the valve chamber 203. The inlet fitting 212 is bored-through or otherwise fabricated to provide a conduit or flow passageway 216 from the inlet adapter port 222 though the valve closure member 204 and out through the outlet fitting 213 when the valve is in an open position. The flow passageway allows fluid to travel into the valve chamber 203 when the valve is in a closed position. The channel 216 has a generally circular cross section within the inlet adapter section 214, but is provided with flat surfaces or flats 227 within the externally threaded portion 225 of the inlet fitting for engagement by a wrench or other tool during assembly and disassembly of the valve body 202.

The housing section 221 of the outlet fitting 213 includes a cylindrical sidewall 234 that reduces to form an outlet socket 235 at the outlet end. The socket 235 includes a generally funnel shaped valve body endwall 236 having a central aperture sized to allow continuation of the flow channel 216 from the outlet socket 235 to the outlet adapter 215 when the valve is in an open position. The inboard portion of the housing section 221 includes an internally threaded portion 237 that terminates in spaced relation to the inlet end 238 of the housing section to allow for receipt of the seal 232.

A central portion of the housing section 221 includes a raised bonnet portion 242 that houses parts of the valve actuating mechanism 205. The bonnet includes a sidewall 243 defining an opening or port 244 into the valve chamber 203. The outboard margin of the sidewall 243 forms a rim 245 for retaining certain parts of the valve actuating mechanism in adjacent relation to the valve chamber 203.

The inlet fitting 212 and outlet fitting 213 are easily assembled to cooperatively form the valve body by engaging the externally threaded portion 225 of the inlet fitting with the internally threaded portion 237 of the housing section, inserting a seal 232 in the corner groove 231 and rotating the threaded sections together until the inlet end 238 of the outlet fitting contacts the shoulder 226 of the inlet fitting. The assembled valve body 202 provides a generally cylindrical internal chamber 203 that functions as part of the flow channel 216 between the inlet adapter port 222 and the outlet adapter port 223.

The fluid flow restricting or valve closure member 204 has an elongate hollow cylindrical or piston-like configuration similar to that previously described and is cyclically slidable back and forth within the chamber 203 from a closed position to the open position shown in FIG. 9. The inlet end of the piston 204 has an opening or port 248 sized to correspond to the inner diameter of the inlet adapter port 222. One or more outlet apertures or ports 249 are positioned slightly inboard of the outlet end of the piston, which terminates in a protuberance or boss 250. When the valve is in an open position as shown in FIG. 9, fluid flowing from the hollow piston passes into the valve chamber 203 and outwardly through the piston outlet port or ports 249. Pairs of circumferential piston inlet and outlet grooves 251 and 252 are formed on the outer surface of the piston body adjacent the ends for receiving respective pairs of piston inlet and outlet seals 253 and 254. The seals engage the interior surfaces of the housing section 221 throughout the linear movement of the piston 204 within the valve body chamber 203 as the piston is moved back and forth between the closed and open positions as previously described. Single or multiple numbers of seals of the types previously described, may be employed.

The piston boss 250 includes a circumferential groove 260 for receiving a seal 261. The boss, groove and seal are configured and sized for engagement of the seal 261 with the inner surface of the outlet adapter 215 at its junction with the outlet socket 235. This junction serves as an integral valve seat 262, for preventing the outward flow of fluid from the valve when the piston 204 is in the fully closed position. Alternate configurations of the boss, groove, and seal in other aspects may be as previously described, and either or both of the inlet endwall of the chamber 233 and outlet socket endwall 236 may be configured to provide a funnel or planar shape, that either or both ends of the piston 204 may include a boss and seal, and that the valve seat 262 may be provided at or adjacent the junctions of either or both of the inlet or outlet adapter and the sidewall of the end fitting connector 221 and/or the junction of the inlet or outlet socket and the respective inlet or outlet adapter. The outer surface of the piston midsection includes an aperture or follower structure 263 that is positioned for reception beneath the bonnet 242. The follower may be generally circular, or it may be formed as an obround, oval, or multilateral slot. The follower may be constructed as previously described.

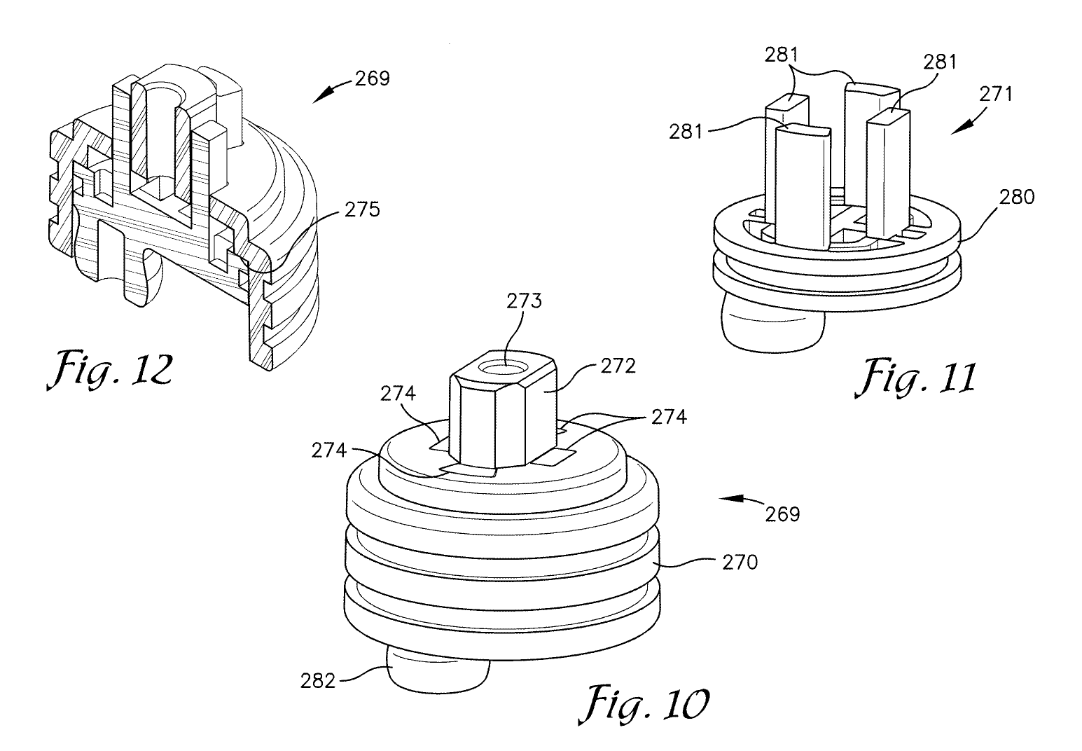

The valve actuating mechanism 205 includes a handle 268 connected with a telescoping cam 269 (FIGS. 10-12) that cooperates with the follower 263 to shift the piston back and forth in linear movement within the valve chamber 203. The cam 269 is configured in two parts to be slid into each other or telescoped for insertion through the outlet fitting 213 when the housing connector 220 is disengaged from the housing section 221 of the outlet fitting.

The cam 269 includes a generally cylindrical body 270 having a hollow for reception of a slidable element 271. The upper portion of the body includes an internal shoulder 275 that serves as a stop when the slidable element is nested within the body. The cam body is connected to a cam shaft 272 having a non-circular cross section, knurling, swaging or any another configuration or surface treatment that allows for gripping engagement of the shaft by the upper portion of the handle 268 to enable rotation of the cam body. The shaft 272 includes an aperture 273 which may be threaded to receive a fastener for connection of the handle with the shaft. One or a plurality of apertures 274 is arranged in spaced relation to the perimeter of the cam shaft 272.

The slidable cam element 271 includes a generally circular base 280 that is sized for sliding reception within the perimeter of the cam body 270. One or a plurality of shafts or legs 281 are fixedly connected with the upper surface of the base 280 and positioned for registry with the one or a plurality of apertures 274. The legs 281 are sized and shaped for slidable reception through the apertures 274 to form a telescopic connection between the cam body and the element 271. An eccentric 282 is fixedly connected to the lower surface of the base 280 in offset relation to a first axis defined by the cam shaft 272. The eccentric is configured for reception within the follower 263 on the surface of the piston 204. The cam 269, including the shaft, body, slidable element, and eccentric are formed of a synthetic or semisynthetic resin or plastic material, although the cam could be constructed of any other suitable material such as a metal, or mixed materials.

The handle 268 includes a handle body 283 configured to enclose the cam shaft 272, which projects outwardly through the handle port 244 and past the bonnet rim 245. The bottom margin of the handle body rests on the surface of the bonnet rim and the hollow interior of the handle body is keyed by an interior sidewall 284 to receive the cam shaft 272. The interior sidewall is also configured to constrain the upstanding legs 281 of the slidable cam element 271 when the handle is fastened in place. Any number of legs 281 may be provided and positioned on the upper surface of the base 280 for engagement by the interior sidewall. A handle lever 288 extends from one side of the outer sidewall 283. The handle body 283 includes a central aperture 289 to receive a fastener 290 such as a threaded fastener therethrough for engagement with the aperture 273 in the camshaft.

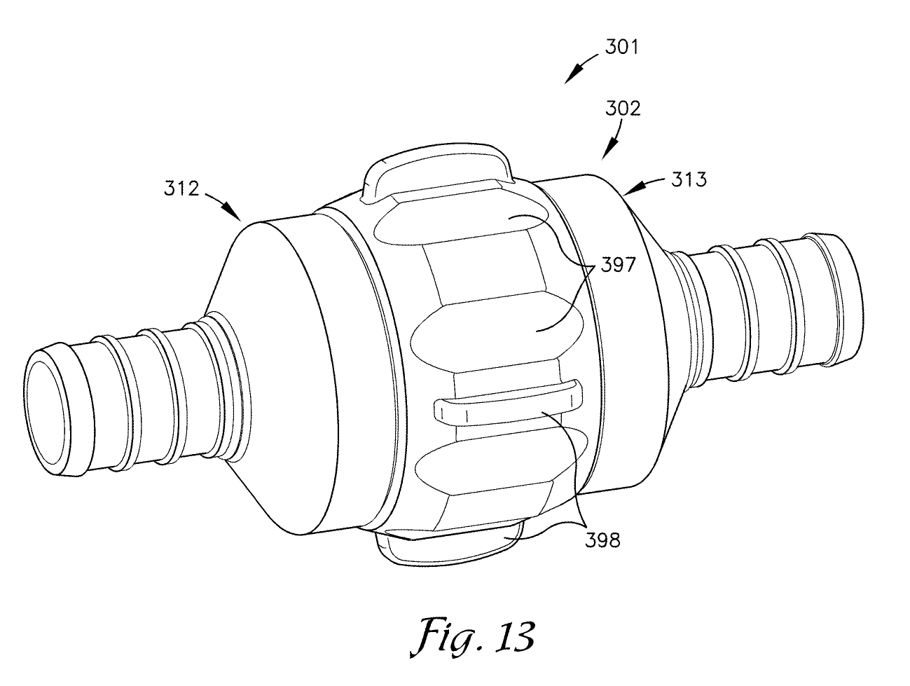

In a method of assembling the presently disclosed embodiment of a valve 201, the cam slidable element 271 is telescoped or nested with the cam body 270 by inserting the legs 281 into the apertures 274 and sliding the element 271 until the upper surface of the element base 280 is stopped by contact with the internal shoulder 275. This collapses the cam 269 along the axis of the shaft 272 to a size that can be received within the valve chamber 203. The eccentric 282 may extend slightly below the cam body 270 ash shown in FIGS. 10 and 12, or it may be fully telescoped within the cam. In this telescoped or nested configuration the cam 269 can then be inserted through the inlet end 238 of the outlet fitting 213 and into the valve chamber 203. The cam is then urged along the second axis within the chamber to the bonnet 242 and urged outwardly through the handle port 244 and into the bonnet 242.

A piston is provided with the piston inlet, outlet, and boss seals 253, 254 and 261 disposed within the respective seal grooves 251, 252 and 260 for sealing between the piston and the inner surface of the chamber 203. The piston is positioned for insertion into the valve body so that the follower 263 will be aligned with the cam eccentric 282. The piston is next inserted through the inlet end of the outlet fitting and into the valve chamber. The outwardly extending cam legs 281 are depressed until they are aligned with the upper surface of the cam body 270, either manually or by positioning the handle 268 so that the interior sidewall 284 rests atop the legs 281, urging the handle and legs toward the valve body until the cam is fully extended and the handle contacts the bonnet 242. The handle 268 is secured in place atop the bonnet 242 by inserting the fastener 290 though the aperture 289 and into the aperture 273 in the cam shaft. Tightening the fastener snugs the handle interior sidewall 284 against the tops of the legs 281, thereby retaining the slidable element 271 in place with the cam 269 in its extended position.

The inlet fitting 212 is secured to the outlet fitting 213 by positioning the seal 232 in the groove 231 of the housing connector section 220, engagement of the externally threaded portion 225 of housing connector section 220 with the internally threaded portion 237 of the housing section 221 and rotating the fittings 212 and 213 until the inlet end 238 of the outlet fitting contacts the inlet fitting shoulder 226.

In use, to close the valve from the open position shown in FIG. 9, an operator grasps the lever 288 and rotates it. Rotation of the handle lever causes corresponding rotation of the cam shaft 272 and the legs 281, which function as extensions of the cam shaft, moving the eccentric 282 within the follower 263 to urge the piston 204 to travel in sealing relation along the second axis within the valve chamber 203 toward the valve seat 262. When the handle lever has been rotated about 90° or any other preselected distance about the axis of the cam shaft as previously described, the piston is moved within the chamber 203 to fully close the valve. This movement shifts the piston away from the inlet endwall 233 of the chamber toward the outlet socket endwall 236 so that the piston boss is received within the inlet end of the outlet fitting 213 and the piston boss seal 261 engages the valve seat 262. The passage of additional fluid beyond the piston boss seal 261 and into the outlet adapter 215 is thereby prevented. Reverse rotation of the handle lever 288 by a user urges the piston boss seal away from the valve seat and opens the fluid channel 216, enabling the passage of fluid outwardly through the outlet adapter port 223. The valve may also be rotated fewer than the number of degrees required to fully open or close the valve to control the flow of fluid through the valve.

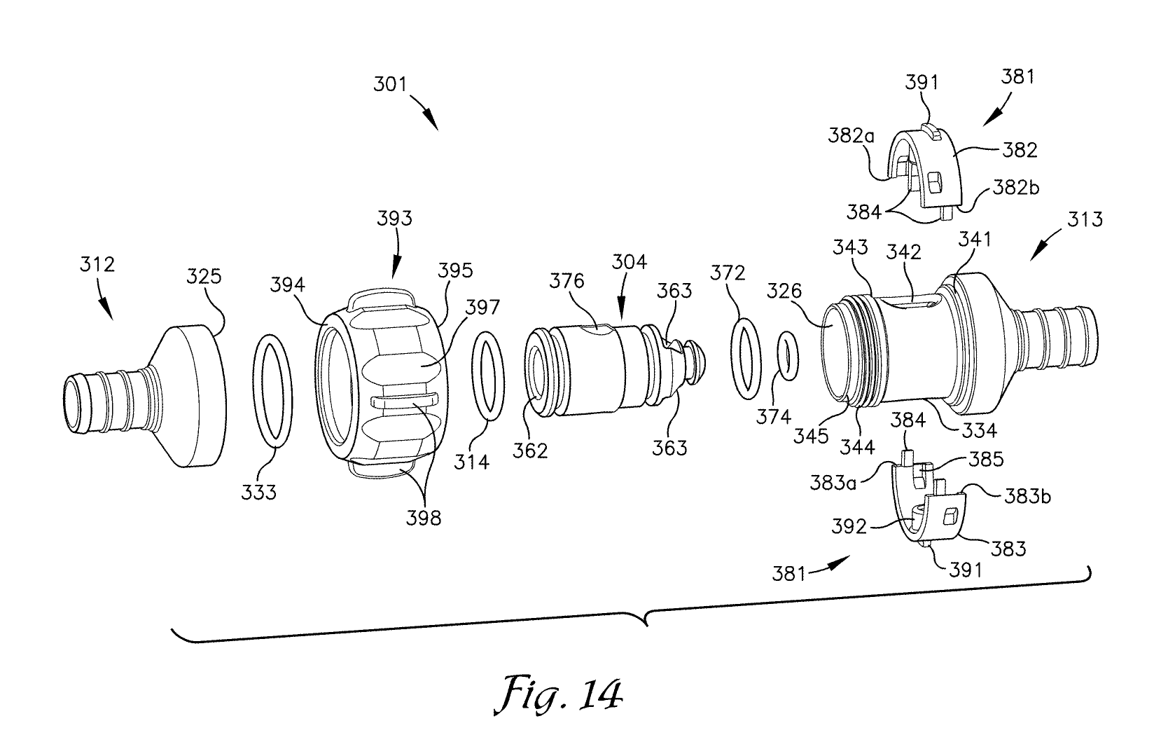

An alternate embodiment of a fluid control valve 301 valve is shown in FIGS. 13-16. The valve 301 includes an elongate valve body assembly 302 having a generally cylindrical internal chamber 303 that constrains a flow restricting or valve closure member 304 that is operable by a valve actuating mechanism 305 to open and close the valve.

The valve body assembly 302 includes generally hollow inlet and outlet fittings 312 and 313 that interconnect to form a channel 316 for the passage of fluid through the valve body. The inlet and outlet fittings 312 and 313 each include a respective inlet or outlet adapter section 314 and 315 connected with a respective inlet or outlet housing section 320 or 321. The inlet adapter 314 includes an inlet port 322, and the outlet adapter 315 includes an outlet port 323. The exterior surfaces of the inlet and outlet adapters 314 and 315 each include a plurality of spaced concentric rings 324 and may be constructed of the same metal or plastic materials as previously described.

Each inlet and outlet housing section 320 and 321 includes a respective inlet or outlet cavity or socket 325 and 326. The inlet socket 325 has a generally cylindrical overall interior configuration including a short, generally cylindrical sidewall connected with a generally planar inlet socket endwall 331. The inlet socket endwall 331 serves as the inlet endwall of the valve chamber 316 and includes a central aperture sized to provide a flow passageway 316 from the inlet adapter 314 through the valve closure member 304 and out through the outlet fitting 313 when the valve is in an open position. The aperture provides a flow passageway into the valve chamber 303 when the valve is in a closed position. The interior surface of the inlet socket sidewall is equipped with a series of threads 332 that terminate in spaced relation to the socket endwall 331 to allow space for reception of a seal 333 as previously described.

The outlet socket 326 has the interior configuration of a reducing coupling, including an elongate generally cylindrical sidewall portion 334 connected to a generally funnel-shaped outlet socket interior endwall 335. The socket endwall 335 serves as the outlet endwall of the valve chamber 303 and includes a central aperture sized to allow continuation of the flow channel 316 from the outlet socket 326 to the outlet adapter 315 when the valve is in an open position.

The external surface of the outlet socket sidewall 334 includes an annular step down 341 inboard of the socket endwall 335 for supporting a portion of the valve actuating mechanism 305. The central portion of the external surface of the sidewall 334 is still further axially relieved to form a generally smooth surface and includes a pair of generally oval apertures 342 through opposed areas of the sidewall. The inboard end of the socket sidewall 334 includes an annular step up 343 for supporting another portion of the valve actuating mechanism. A series of threads 344 is positioned inboard of the step 343 for engagement with the inlet socket threads 332 to hold the inlet and outlet housing sections together to form the valve body 302. Further inboard of the threads 344, a smooth annular surface 345 is provided for engagement with the inlet socket seal 333 when the fittings are engaged.

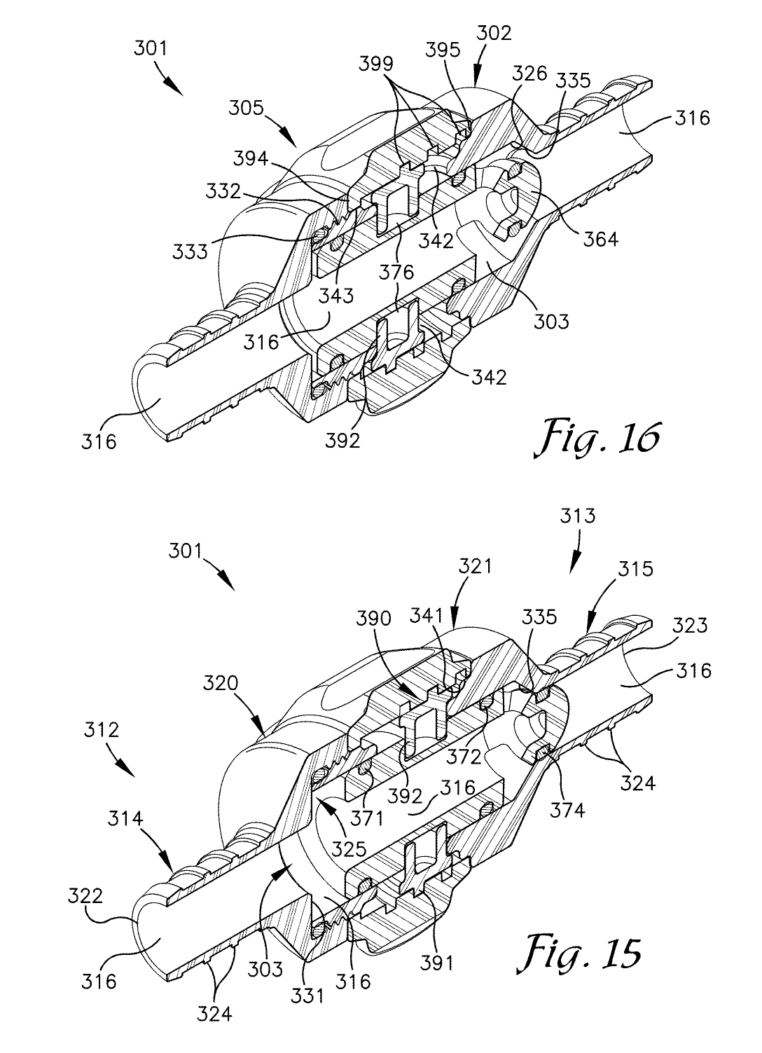

The fluid flow restricting or valve closure member 304 is preferably configured in the form of an elongate hollow cylinder or piston that is cyclically slidable back and forth within the chamber 303 from the closed position shown in FIG. 15 to the open position shown in FIG. 16. The Piston 304 includes an inlet end and an outlet end. The inlet end includes an inlet port 362 configured for unobstructed flow of a fluid from the inlet adapter port 322. One or more outlet ports 363 are positioned slightly behind the outlet end, which terminates in a boss 364. The outlet ports 363 allow passage of fluid through the hollow piston into the valve chamber 303 and out through the outlet fitting 313 when the valve is in an open position. The outer surface of the piston body adjacent the each of the inlet and outlet ends includes a circumferential groove 365 and 366 for mounting respective inlet and outlet seals 371 and 372. The seals engage the interior surfaces of the outlet socket 325 throughout the linear back and forth movement of the piston 304 within the chamber 303. The seals are 371 and 372 are shown as single O-rings, but pairs of grooves and corresponding O-rings may also be provided and constructed of materials as previously described.

The piston boss 364 is smaller in diameter than the remainder of the piston 304 and includes a circumferential groove 373 for mounting a seal 374. The boss, groove and seal are configured and sized for engagement of the seal 374 with the inner surface of the inlet end of the outlet adapter 315, which serves as an integral valve seat 375 for preventing outward fluid flow from the valve when the piston 304 is in the fully close position. It is foreseen that the seal 304 may also be configured for engagement with a seat element such as a seat ring connected with the outlet end of the adapter 315. It is also foreseen that the boss, groove, and seal may be configured for engagement of the seal 374 with the inner surface of the outlet end of the inlet adapter 314, or with a seat element connected with the outlet end of the inlet adapter 314.

The midsection of the piston 304 includes a pair of apertures 376, each designed to receive an engagement portion of a cam follower assembly 381. The apertures 376 are generally obround, but may also be circular, multilateral, or of any other suitable shape. The apertures 376 are generally positioned for alignment with the socket apertures 342 of the outlet fitting 313.

The cam follower assembly 381 is in the form of a clip having a generally annular outer profile that is constructed in two parts, a first clip section 382 and a second clip section 383, each having a generally semicircular overall outer profile. Each clip section 382 and 383 has a pair of respective ends 382a, 382b and 383a and 383b. Each of the ends is equipped with a tongue 384 and a hole or groove 385 that are configured for engagement when the ends 382a and 383a are joined and 382b and 383b are joined to form the annular clip.

Each clip section includes a cam follower 390. The outer surface of each clip section includes a track-engaging follower portion or tab 391. The corresponding inner surface of each clip section includes a piston-engaging follower portion or shank 392. The followers are aligned so that each subtends an angle with the inlet and outlet-facing edges of its respective clip section 382 or 383 so that the tabs 391 cooperatively form spaced apart segments of a helical thread. The follower shanks 392 are sized, shaped, and positioned for reception through the socket apertures 342 and into the piston apertures 376.

In one aspect, each tab 391 is configured to extend the full length of its respective clip section. Thus, one tab is configured to extend between the ends 382a and 382b of clip section 382, and the other tab is configured to extend between the ends 383a and 383b of clip section 383, so that when the ends 382a and 382a are joined and 382b and 383b are joined, the tabs form a continuous helical thread. In another aspect, each clip section includes a plurality of cam followers 390. Thus the outer surface of each clip sections includes a plurality of tabs 391 and the corresponding inner surface of each clip section includes a plurality of shanks 392.

The clip sections, including the tab portions and shank portions of the followers 390 are preferably of integral construction and are formed of a synthetic or semisynthetic resin or plastic material. In other aspects, the cam follower could be constructed of another suitable material, such as a metal or ceramic, or the follower could be constructed of mixed materials, such as one or more plastic portions connected with one or more metal or ceramic portions.

The valve actuating mechanism 305 includes a rotatable ring 393 having an inlet fitting end 394 and an outlet fitting end 395. The outer surface of the ring is equipped with a plurality of interspersed axially oriented finger grooves 397 and radially projecting flanges 398 to facilitate grasping and rotation of the ring 393 by a user. In another aspect, knurling or swaging may be substituted for the grooves and flanges. In still another aspect, the outer surface of the ring 393 may be configured for rotation using a wrench, in which case it may include a pair of opposed flat areas or a multilateral outer profile such a hexagon. As best shown in FIGS. 15 and 16, the inner surface or bore of ring 393 includes a helical groove or track 399 that functions as a closed cam track by transferring the rotary motion of the ring 393 into linear motion of the piston 304 back and forth within the chamber 303 to open and close the valve. The track 399 and follower tabs 391 are configured and sized for reception of the follower tabs 391 within the track 399, the rotatable ring 393 and track 399 are configured for shifting the valve from its fully open position shown in FIG. 16 to its fully closed position shown in FIG. 15 (or vice versa) by rotation of the ring a full turn or about 360° in the appropriate direction, and in some aspects by rotation of the ring a three quarter turn or about 270°, and in some aspects a half turn or about 180°, and in some aspects a quarter turn or about 90°, or any predetermined distance or number of degrees in the appropriate direction.

In a method of assembling the fluid control valve of the presently disclosed embodiment, the piston inlet, outlet, and boss seals 371, 372, 374 are disposed within their respective seal grooves 365, 366 and 373. The piston 304 is next disposed within the outlet fitting 313 and the cam follower assembly clips 382 and 383 are positioned with the follower shanks 392 disposed through the outlet socket apertures 342 and into the piston apertures 376. The tongues and holes or grooves 384 and 385 are connected together in encircling relation to the outlet socket sidewall 334 and to form the annular cam follower assembly 381. The track 303 is aligned with the cam follower tabs 391 and the ring 393 is rotated onto the follower assembly 381 until the outlet fitting end of the ring engages the outlet socket step 341 and the and the inlet fitting end 394 or the ring engages the outlet socket step 343. The inlet socket weal 333 is installed adjacent the inlet socket sidewall 331 and the inlet socket threads 332 are aligned for engagement with the outlet socket threads 344. Once the threads are aligned, they are engaged and the inlet fitting 312 and/or outlet fittings 313 are rotated until the respective threads are fully engaged and the rotatable ring 393 is constrained against axial movement by the inlet and outlet fitting ends 394 and 395.

In use, to close the valve from the open position shown in FIG. 16, an operator grasps the rotatable ring 393 and rotates it counter clockwise about 360° or any other preselected number of degrees as previously described. Rotation of the ring 393 causes corresponding rotation of the track 399 on the inner surface of the ring. Because the ring is constrained against axial travel, rotation of the track transmits corresponding motion to the follower tab 391 riding in the track 399, which in turn moves the attached follower shank 392 constrained within the piston apertures 376, which in turn urges the piston 304 in sealing relation along the second axis within the valve chamber 303 toward the outlet adapter 315. When the ring 393 has been rotated about 360° about the axis of the valve body assembly 302, the piston is moved within the chamber 303 to fully close the valve. In this position, the piston is shifted away from the inlet adapter 314 and toward the outlet adapter 315 so that the piston boss is received within the inlet end of the outlet adapter and the piston boss seal 374 engages the valve seat 375. Fluid is prevented from further passage beyond the piston boss seal 374 and into the outlet adapter 315. Reverse rotation of the ring 393 by a user urges the piston boss seal away from the valve seat and opens the fluid channel 316, enabling passage of fluid outwardly past the piston boss 364 and through the outlet adapter 315. Reverse rotation of the ring may be continued until it has been rotated the preselected number of degrees required to fully open the valve.

Those skilled in the art will appreciate that in the previously described embodiments of a fluid control valve any one or more or all of the described parts such as inlet and outlet fittings, valve bodies, pistons and valve actuating mechanisms may be constructed of any suitable material such as a metal such as brass, bronze, steel or stainless steel or a synthetic or semisynthetic resin or plastic material. The resulting valve may include parts fabricated of various materials, including ceramics. The piston and valve chamber may be cylindrical or they may be fabricated to present a multilateral or any other cross section so long as a sealing surface may be maintained between the piston and the surface of the valve chamber and the valve seat. While exemplary valve closure members or pistons described herein are depicted as preventing the flow of liquid through the valves by sealing engagement with valve seats located on the outlet sides of valve bodies, the positions of the pistons and valve seats may be reversed for location at the inlet sides of the valve bodies. It is also foreseen that the valve closure members may be configured for sealing engagement with valve seats located on both the inlet and outlet sides of the valve bodies, and that the number of seals performing a function may vary, so that a plurality of may be substituted for a single seal, and a single seal may be substituted for a plurality of seals.

While certain forms of the fluid control valve have been selected and described herein to illustrate the present invention, those skilled in the art will understand that various changes and modifications can be made without departing from the scope of the invention as defined in the appended claims. The foregoing description of embodiments of the valve is provided for purposes of illustration only, and not for the purpose of limiting the invention as defined by the appended claims and their equivalents

1. A valve, comprising:
a. a valve body including an inlet fitting and an outlet fitting interconnected by a central housing member;
b. the housing member including a first housing section and a second housing section;
c. the first and second housing sections are configured to engage the inlet and outlet fittings in fixed orientation and spaced relation to cooperatively form the valve body;
d. the valve body defining an elongate chamber having an inlet and an outlet at opposite ends of the chamber;
e. a piston disposed within the chamber and including a first seal, the piston being slidable from a closed position in which the first seal engages a seat to restrict flow through the valve to an open position in which the first seal is displaced from the seat to allow flow through the valve;
f. a valve actuator including a cam disposed within the valve chamber and operably engaged with the piston;
g. the cam having a shaft extending outwardly through the valve body; and
h. a handle disposed outside the valve body and connected in driving relation to the cam shaft so that the cam may move the piston between the closed and open position by turning the handle along a first axis defined by the cam shaft.

2. The valve of claim 1, wherein:
a. the piston is moved along a second axis between the open and closed positions; and
b. the piston includes a channel coaxial with the second axis, the channel configured to allow fluid flow through the channel when the valve is in the open position.

3. The valve of claim 2, wherein a portion of the outer surface of the piston includes a cam follower configured to engage the cam and translate the motion of the cam to the piston, causing the piston to travel along the second axis between the open and closed positions.

4. The valve of claim 2, wherein an opposed portion of the outer surface of the piston is configured to include a centering member that rides back and forth between guides on the interior of the housing.

5. The valve of claim 1, further including:
a. a second seal is provided between the piston and the inlet fitting;
b. a third seal is provided between the piston and the outlet fitting; and
c. the second and third seals are configured to seal the interface between the piston and the valve body.

6. The valve of claim 1, wherein the seat comprises an inner surface of at least one of the inlet or the outlet.

7. The valve of claim 1, further including a key assembly configured on the valve actuating mechanism and comprising:
a. a tab operably coupled with an arm; and
b. the arm is configured for cyclic rotation between a locked position where the arm is wedged against a housing section of the valve body for maintaining the valve actuating mechanism in a specified orientation and an unlocked position where the arm is not wedged against a housing section of the valve body to allow the handle to be turned to drive the cam shaft.

8. The valve of claim 1, wherein the cam, shaft, and handle are of integral construction.

9. The valve of claim 1, wherein the first and second housing sections are held in place by at least one band encircling the valve body.

10. A valve, comprising:
a. a valve body including an inlet fitting coupled with an outlet fitting;
b. the valve body defining an elongate chamber having an inlet and an outlet disposed at opposite ends of the chamber;
c. a piston disposed within the chamber and including a first seal, the piston being slidable along an axis within the chamber from a closed position in which the first seal engages a seat to restrict flow through the valve to an open position in which the first seal is displaced from the seat to allow flow through the valve;
d. a rotatable ring encircling the valve body in coaxial relation to the axis;
e. a cam track disposed on the inner surface of the ring whereby rotation of the ring causes rotation of the cam track; and
f. a follower having a first end and a second end, the first end engaging the cam track and the second end extending inwardly through the valve body and operably engaging the piston so that the cam track may move the piston between the closed and open position by rotating the ring about the axis.

11. The valve of claim 10, wherein the piston includes a channel coaxial with the axis, the channel configured to allow flow through the channel when the valve is in the open position.

12. The valve of claim 10, wherein the follower further comprises:
a. a follower ring having a first follower ring section and a second follower ring section, each ring section connected with a follower having a first end for engaging an area of the cam track and a second end for engaging an area of the piston; and
b. the first and second follower ring sections configured for mutual engagement encircling the valve body between the valve body and the rotatable ring.

13. The valve of claim 10, wherein:
a. a second seal is provided between the piston and the inlet fitting;
b. a third seal is provided between the piston and the outlet fitting; and
c. the second and third seals are configured to seal the interface between the piston and the valve body.

14. The valve of claim 10, wherein the seat comprises an inner surface of at least one of the inlet or the outlet.

15. A valve, comprising:
a. a valve body including an inlet fitting coupled with a housing having a bonnet and an outlet fitting;
b. the valve body defining an elongate chamber having an inlet and an outlet at opposite ends of the chamber;
c. a piston disposed within the chamber and including a first seal, the piston being slidable from a closed position in which the first seal engages a seat to restrict flow through the valve to an open position in which the first seal is displaced from the seat to allow flow through the valve;
d. a valve actuator including a cam operably engaged with the piston;
e. the cam having a first part and a second part, the first part including a generally hollow body connected to a cam shaft;
f. the cam second part having a base connected with a cam eccentric;
g. the cam second part slidable between a collapsed position in which the base is positioned within the hollow body of the first part and an extended position in which the eccentric is disposed within the valve chamber and operably engaged with the piston, and
h. a handle disposed on the bonnet and connected in driving relation to the cam shaft so that the cam may move the piston between the closed and open position by turning the handle along a first axis defined by the cam shaft.

16. The valve of claim 15, wherein:
a. the cam second part includes a plurality of spaced-apart legs; and
b. the cam first part includes a plurality of apertures positioned for sliding reception of respective ones of the spaced-apart legs when the cam is in the collapsed position.

17. The valve of claim 15, wherein:
a. the piston is moved along a second axis between the open and closed positions; and
b. the piston includes a channel coaxial with the second axis, the channel configured to allow flow through the channel when the valve is in the open position.

18. The valve of claim 17, wherein a portion of the outer surface of the piston includes a cam follower configured to engage the cam and translate the motion of the cam to the piston, causing the piston to travel along the second axis between the open and closed positions.

19. The valve of claim 15, further including:
a. a second seal is provided between the piston and the inlet fitting;
b. a third seal is provided between the piston and the outlet fitting; and
c. the second and third seals are configured to seal the interface between the piston and the valve body.

20. The valve of claim 15, wherein the seat comprises an inner surface of at least one of the inlet or the outlet.
